(19) United States
(12) Patent Application Publication
(10) Pub. No.: US 2026/0325392 A1
(43) Pub. Date: Oct. 22, 2026

(54) EXERCISE DEVICE

(71) Applicant: Yevgeny GOFMAN, Beer Sheva (IL)

(72) Inventor: Yevgeny GOFMAN, Beer Sheva (IL)

(21) Appl. No.: 19/549,225

(22) Filed: Feb. 25, 2026

Related U.S. Application Data
(60) Provisional application No. 63/765,832, filed on Mar. 3, 2025.

(51) Int. Cl. A61H 7/00

(52) U.S. Cl. CPC A61H 7/007; A61H 2201/01; A61H 2203/0425

(57) ABSTRACT

An exercise device configured for stable placement on a sitting surface is provided. The device comprises a base and side walls vertically extending from the lateral ends of the base. The side walls include multiple engageable supports configured to receive and rotatably support the ends of a plurality of rigid shafts arranged horizontally therebetween. The rigid shafts are configured to support a person seated thereon. Furthermore, the engageable supports are interspaced and elevated with respect to the base to enable the free rotation of the supported rigid shafts, thereby facilitating the forward and rearward dynamic movement of the seated person.

### CROSS REFERENCE TO RELATED APPLICATIONS

This application claims the benefit of priority of U.S. Provisional Patent Application No. 63/765,832, filed Mar. 3, 2025, the contents of which are all incorporated herein by reference in their entirety.

### FIELD OF THE INVENTION

The present invention relates to exercise equipment. More specifically, the invention relates to an exercise device that facilitates dynamic motion for users in a seated position.

### BACKGROUND OF THE INVENTION

In recent years, there has been an increasing recognition of the health risks associated with prolonged sedentary behavior, particularly the extended periods of static sitting prevalent in modern lifestyles. The negative implications of such inactivity are well-documented, contributing to various health issues such as cardiovascular diseases, obesity, and musculoskeletal disorders.

Traditional exercise equipment, such as stationary bicycles or seated ellipticals, may partially address the issue. However, they frequently require a dedicated setup and can be intrusive in everyday environments, particularly during prolonged office desk work, limiting their practical application for users seeking to integrate movement seamlessly into their routine activities.

The present invention is aimed at providing a suitable solution that facilitates dynamic user movement while seated, providing a practical solution that seamlessly integrates into the user's routine.

### SUMMARY OF THE INVENTION

In one aspect, the invention relates to an exercise device, comprising: a) a base configured to facilitate stable placement of said exercise device on a sitting surface; b) side walls that vertically extend from the lateral ends of said base, said side walls comprise multiple engageable supports configured to receive and rotatably support the ends of multiple shafts arranged therebetween; and c) a plurality of rigid shafts configured to support a person seated thereon, said rigid shafts are horizontally arranged between said side walls and are rotatably connected thereto via said engageable supports, wherein said engageable supports are interspaced and are elevated respective to said base to enable the free rotation of the supported rigid shafts and, thereby, the forward and rearward movement of a person seated thereon

According to an embodiment of the present invention, the invention relates to an exercise device, comprising: a) a base configured to facilitate stable placement of said exercise device on a sitting surface; b) side walls that vertically extend from the lateral ends of said base, said side walls comprise multiple engageable supports configured to receive and rotatably support the ends of multiple shafts arranged therebetween; and c) a plurality of rigid shafts configured to support a person seated thereon, said rigid shafts are horizontally arranged between said side walls and are rotatably connected thereto via said engageable supports, wherein said engageable supports are interspaced and are elevated respective to said base to enable the free rotation of the supported rigid shafts and, thereby, the forward and rearward movement of a person seated thereon, and wherein the interspaces between the engageable supports and the diameter of said rigid shafts are predetermined to distribute the pressure applied by said rigid shafts on body portions of the seated person.

According to another embodiment of the present invention, the invention relates to an exercise device, comprising: a) a base configured to facilitate stable placement of said exercise device on a sitting surface; b) side walls that vertically extend from the lateral ends of said base, said side walls comprise multiple engageable supports configured to receive and rotatably support the ends of multiple shafts arranged therebetween; and c) a plurality of rigid shafts configured to support a person seated thereon, said rigid shafts are horizontally arranged between said side walls and are rotatably connected thereto via said engageable supports, wherein said engageable supports are interspaced and are elevated respective to said base to enable the free rotation of the supported rigid shafts and, thereby, the forward and rearward movement of a person seated thereon, wherein one or more support connections comprise recessions in the side walls.

According to yet another embodiment of the present invention, the invention relates to an exercise device, comprising: a) a base configured to facilitate stable placement of said exercise device on a sitting surface; b) side walls that vertically extend from the lateral ends of said base, said side walls comprise multiple engageable supports configured to receive and rotatably support the ends of multiple shafts arranged therebetween; and c) a plurality of rigid shafts configured to support a person seated thereon, said rigid shafts are horizontally arranged between said side walls and are rotatably connected thereto via said engageable supports, wherein said engageable supports are interspaced and are elevated respective to said base to enable the free rotation of the supported rigid shafts and, thereby, the forward and rearward movement of a person seated thereon, wherein one or more support connections comprise cylindrical holes in the side walls.

According to certain embodiments of the present invention, the invention relates to an exercise device, comprising: a) a base configured to facilitate stable placement of said exercise device on a sitting surface; b) side walls that vertically extend from the lateral ends of said base, said side walls comprise multiple engageable supports configured to receive and rotatably support the ends of multiple shafts arranged therebetween; and c) a plurality of rigid shafts configured to support a person seated thereon, said rigid shafts are horizontally arranged between said side walls and are rotatably connected thereto via said engageable supports, wherein said engageable supports are interspaced and are elevated respective to said base to enable the free rotation of the supported rigid shafts and, thereby, the forward and rearward movement of a person seated thereon, wherein one or more ends of the plurality of rigid shafts comprise end connectors configured to secure their rotatable connection with the engageable supports of the side walls.

According to an embodiment of the present invention, the invention relates to an exercise device, comprising: a) a base configured to facilitate stable placement of said exercise device on a sitting surface; b) side walls that vertically extend from the lateral ends of said base, said side walls comprise multiple engageable supports configured to receive and rotatably support the ends of multiple shafts arranged therebetween; and c) a plurality of rigid shafts configured to support a person seated thereon, said rigid shafts are horizontally arranged between said side walls and are rotatably connected thereto via said engageable supports, wherein said engageable supports are interspaced and are elevated respective to said base to enable the free rotation of the supported rigid shafts and, thereby, the forward and rearward movement of a person seated thereon, wherein at least one rigid shaft is differently deployed respective to other rigid shafts.

According to another embodiment of the present invention, the invention relates to an exercise device, comprising: a) a base configured to facilitate stable placement of said exercise device on a sitting surface; b) side walls that vertically extend from the lateral ends of said base, said side walls comprise multiple engageable supports configured to receive and rotatably support the ends of multiple shafts arranged therebetween; and c) a plurality of rigid shafts configured to support a person seated thereon, said rigid shafts are horizontally arranged between said side walls and are rotatably connected thereto via said engageable supports, wherein said engageable supports are interspaced and are elevated respective to said base to enable the free rotation of the supported rigid shafts and, thereby, the forward and rearward movement of a person seated thereon, wherein at least one rigid shaft is differently deployed respective to other rigid shafts, and is positioned beyond the front or rear end of the base.

According to yet another embodiment of the present invention, the invention relates to an exercise device, comprising: a) a base configured to facilitate stable placement of said exercise device on a sitting surface; b) side walls that vertically extend from the lateral ends of said base, said side walls comprise multiple engageable supports configured to receive and rotatably support the ends of multiple shafts arranged therebetween; and c) a plurality of rigid shafts configured to support a person seated thereon, said rigid shafts are horizontally arranged between said side walls and are rotatably connected thereto via said engageable supports, wherein said engageable supports are interspaced and are elevated respective to said base to enable the free rotation of the supported rigid shafts and, thereby, the forward and rearward movement of a person seated thereon, wherein at least two rigid shafts are deployed to form a deployment pattern that promotes a corresponding movement pattern of a person seated on said device.

According to certain embodiments of the present invention, the invention relates to an exercise device, comprising: a) a base configured to facilitate stable placement of said exercise device on a sitting surface; b) side walls that vertically extend from the lateral ends of said base, said side walls comprise multiple engageable supports configured to receive and rotatably support the ends of multiple shafts arranged therebetween; and c) a plurality of rigid shafts configured to support a person seated thereon, said rigid shafts are horizontally arranged between said side walls and are rotatably connected thereto via said engageable supports, wherein said engageable supports are interspaced and are elevated respective to said base to enable the free rotation of the supported rigid shafts and, thereby, the forward and rearward movement of a person seated thereon, wherein the base is reinforced with honeycomb-shaped ribs.

### BRIEF DESCRIPTION OF DRAWINGS

For a better understanding of various embodiments of the present invention and to show how the same may be carried out, reference is made in the following detailed description, by way of example, to the accompanying illustrative drawings, in which:

FIG. 1 is a perspective view of an exercise device, according to an embodiment of the present invention;

FIGS. 2A-2B illustrate end connectors installed at the ends of each rigid shaft, according to an embodiment of the present invention;

FIG. 3 illustrates an exemplary configuration of side walls, according to an embodiment of the present invention;

FIGS. 4A-4B illustrate end connectors having reduced portions, according to an embodiment of the present invention;

FIG. 5 illustrates side covers with attachment protrusions, according to an embodiment of the present invention.

FIG. 6 illustrates an exemplary assembly of an exercise device with one side cover removed, according to an embodiment of the present invention; and

FIG. 7 illustrates an optional design of the base of an exercise device that comprises honeycomb-shaped reinforcement ribs, according to an embodiment of the present invention.

In the above drawings, details of the invention are illustrated to provide a fundamental understanding of the invention, where the following detailed description, taken with the drawings, makes it apparent to those skilled in the art how certain embodiments of the present invention may be embodied in practice.

### DETAILED DESCRIPTION OF EMBODIMENTS OF THE INVENTION

The present invention provides a seated exercise device designed to facilitate dynamic user movement while maintaining a seated posture. The described embodiment includes various components configured to enhance stability, user comfort, and the effectiveness of exercise regimens.

In the following detailed description, non-limiting embodiments of the present invention are discussed and illustrated, where references are made to accompanying drawings.

These embodiments and accompanying drawings should be understood as non-limiting examples of implementing the present invention. Furthermore, terms such as “optionally”, “for instance”, “for example”, “exemplary”, “e.g.,”, “may”, etc., refer to optional features being selected in certain embodiments of the invention for the sake of simplicity and clear explanation. It should be understood, however, that optional features mentioned in different embodiments may be used, in conjunction and/or separately, to carry out further embodiments of the present invention.

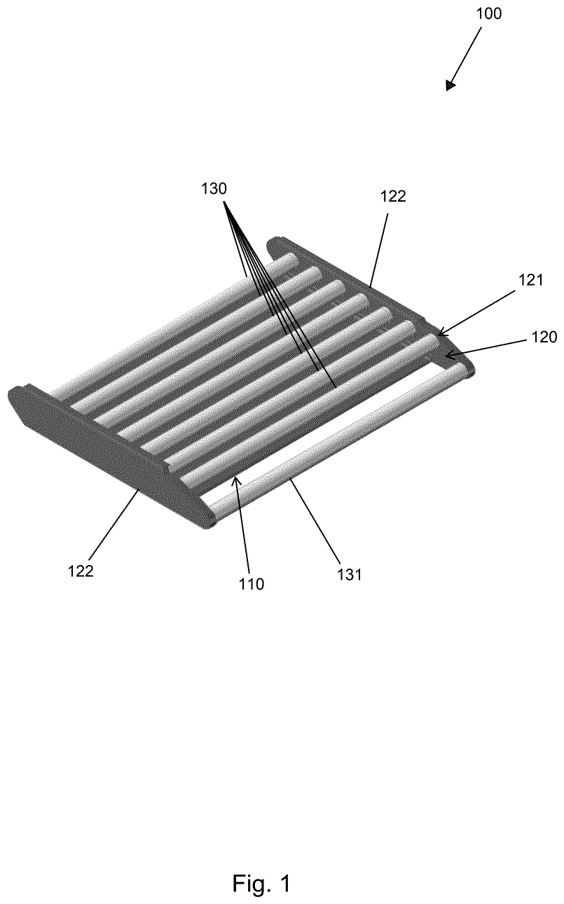

FIG. 1 is a perspective view of an exercise device 100, according to an embodiment of the present invention. Device 100 comprises a base 110, a base structured to stabilize the assembly when positioned on surfaces such as an office chair or other seating platforms. Base 110 provides foundational support that contributes to the device's operational stability during use.

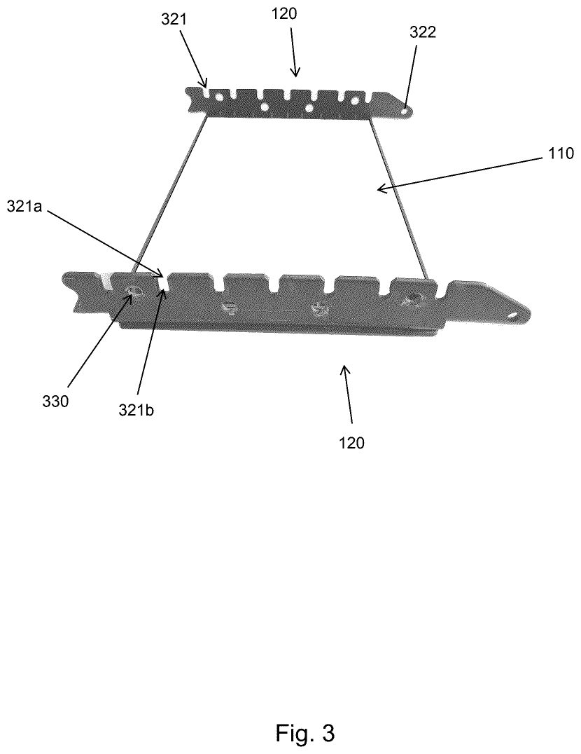

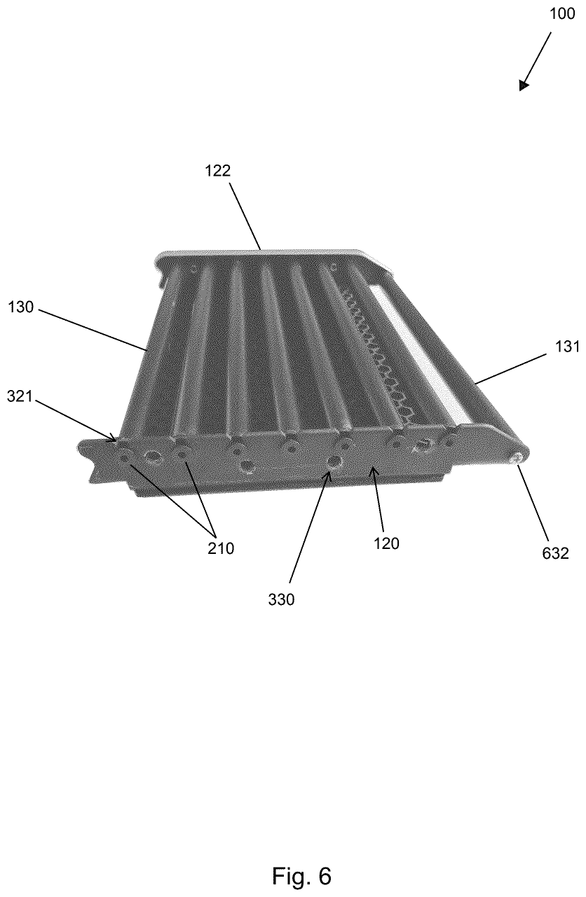

Extending vertically from the lateral ends of base 110 are side walls 120, each of which incorporates engageable supports 121 (partially obscured by side covers 122 in FIG. 1 and further illustrated and described in FIGS. 3 and 6). These supports are configured and arranged to receive and secure the ends of a plurality of rigid shafts 130 horizontally extending between side walls 120. The spatial arrangement of engageable supports 121 and, thus, of rigid shafts 130 relative to base 110 (e.g., their interspacing and their elevation respective to base 110) allow for the smooth rotation of shafts 130, which in turn accommodates the forward and rearward movement of a user seated on device 100.

Shafts 130 are designed with either a partially or entirely hollow profile, featuring material properties and section thickness sufficient to withstand the weight of a seated person without bending. The shafts' rotational capability is facilitated by their interface with engageable supports 121, thereby facilitating dynamic movement for the seated person.

In various embodiments, the rigid shafts 130 may be fabricated from a variety of durable materials suitable for bearing the weight of a seated user without deformation, including, but not limited to, extruded aluminum, carbon fiber composites, reinforced polymers, wood, or a combination thereof. Additionally, the external surface of one or more of the rigid shafts 130 may comprise specific surface treatments or textured topographies configured to enhance user comfort and the effectiveness of the exercise regimen. For instance, the shafts 130 may be coated with a rubberized or silicone layer to provide a comfortable grip and reduce localized pressure points. Alternatively or additionally, the external surface of the rigid shafts 130 may feature a textured topography, such as a plurality of bumps, longitudinal ridges, or wave patterns, designed to amplify the massaging effect on the user's thighs and further stimulate blood flow therethrough as the shafts rotate.

An important consideration in the design of exercise device 100 is pressure distribution across the user's body portions supported on rigid shafts 130. The predetermined spacing between engageable supports 121 and the diameter of shafts 130 are predetermined to optimize pressure distribution across the user's body. This configuration enhances comfort and maximizes the effectiveness of the exercise regimen by reducing localized pressure concentrations, which could lead to discomfort. Nevertheless, in certain configurations, the spacing between engageable supports 121 and the diameter of rigid shafts 130 are predetermined to cause minor discomfort to a user who maintains a prolonged static position, thereby encouraging the user to perform certain forward/rearward movements, thereby avoiding static pressure on the thighs. In this manner, the applied pressure massages the user's thighs and stimulates the blood flow therethrough.

Notably, the external faces of side walls 120, along with the detailed view of engageable supports 121, are partially obscured in FIG. 1 by side covers 122 and are further illustrated and explained in FIGS. 3 and 6. Further shown in FIG. 1 is an individual rigid shaft 131, which is similarly designed to shafts 130, yet is separated and differently elevated therefrom. Shaft 131 may be positioned in the common depression, for instance, between an armchair's seat and backrest to stabilize device 100 thereon. Alternatively, device 100 may be placed with shaft 131 protruding beyond the front or rear end of the base to press and massage the user's upper calf, for instance, when the user slightly elevates and descends his knees.

The adaptability of the device allows for differential shaft deployment of any of shafts 130 and 131. By varying the spatial arrangement of at least one pair of engageable supports, specific shafts may extend beyond either the front or rear end of the base. This capability allows for customizable movement patterns, which can be tailored to suit various exercise routines for the user.

Furthermore, device 100 may be designed with different deployment patterns, such as with different elevations of the rigid shafts 130 that promote targeted user movement. These patterns can be adjusted to various movement regimens that stimulate further muscles of the seated person.

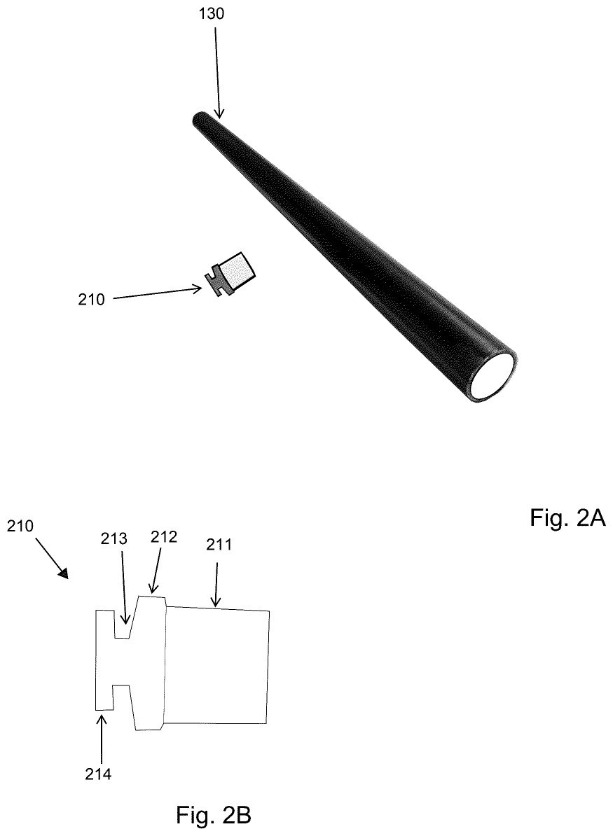

In certain embodiments of the present invention, rigid shafts 130 comprise end connectors 210 installed at the ends of each rigid shaft, as illustrated in FIGS. 2A-2B, to establish their rotatable connection with engageable supports 121, These connectors exhibit varying diameters across distinct portions, such as in the optional configuration shown in FIG. 2B, comprising: an initial insertion section 211, the outer diameter of which corresponds to the inner diameter of shaft 130 for either a pressure-fit or a threaded connection therebetween; a subsequent shoulder section 212 that constitutes an insertion restriction of section 211 into shaft 130; a neck section 213 that establishes a clamping depression aligned with the corresponding engageable supports 121 of side walls 120 and facilitates the rotational engagement therewith; and an outermost clamping portion 214 that features a larger diameter than the engageable support 121, which secures the engagement between the supported connectors 210 and the engageable supports 121 of side walls 120. The construction materials and interfaces of connectors 210 and engageable support 121 or the entire side walls 120 are configured to reduce abrasion caused by friction therebetween due to the rotation of rigid shafts 130, thus enhancing durability. Furthermore, it is noted that the simple design of connectors 210 simplifies the manufacturing process and assembly time of device 100. thus reducing its manufacturing and maintenance costs and time.

Moreover, in certain embodiments of the present invention, connectors 210 are intentionally fabricated with abradable surface at its interface with engageable supports 121 (e.g., at the surface of neck section 213), rendering the same to be worn faster than engageable supports 121, thus protecting the latter from excessive wear and improving the overall life span of device 100 for the price of a periodical replacements of the low-cost connectors 210. Nevertheless, connectors 210 may be configured with surface materials that can significantly reduce their friction at the interface with engageable supports 121, thereby increasing their endurance even under intense use of device 100.

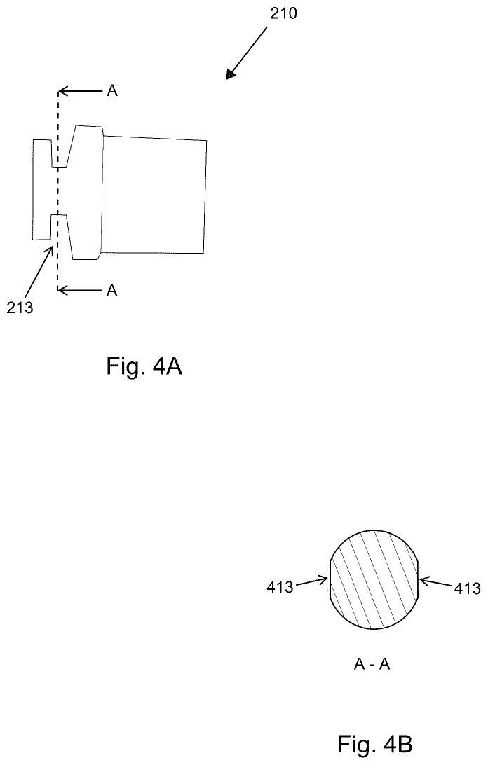

FIG. 3 illustrates an exemplary configuration of side walls 120, according to an embodiment of the present invention. In this embodiment, engageable supports 121 comprise recessions 321 configured with engagement grooves 321a through which the neck section 213 of connectors 210 may be slid downwardly into cylindrical support portions 321b that establish rotatable support of end connectors 210. Engagement grooves 321a may be slightly narrower than cylindrical support portions 321b and neck section 213 so that the neck section 213 should be pressed to allow its passage therethrough, thereby preventing undesired disengagement of neck section 213 from support portions 321b. Optionally, neck section 213 may have depressed/honed portions 413, as illustrated in FIG. 4B, to provide an easier passage of neck section 213 through engagement grooves 321a, thus, assembly/disassembly of shafts 130 when rotated at the corresponding angle relative to cylindrical support portions 321b, while maintaining shafts 130 engaged during the routine use of device 100.

Notably, the abovementioned configuration of connectors 210 obviates the need for using bearings and similar coupling elements, thus reducing the manufacturing and maintenance costs of device 100 and improving its overall reliability. Furthermore, in certain embodiments of the invention, neck section 213 is predesigned with reduced robustness with respect to support portions 321b. Therefore, in the occurrence of abrasion therebetween, the worn connectors 210 may be easily replaced rather than requiring a more expensive repair of side walls 120.

Furthermore, one or more engageable supports 121 may comprise cylindrical holes 322 (e.g., in lieu of or combined with recessions 321), through which suitably sized bolts are threaded and connected to the ends of rigid shafts 130 or 131 to allow the shafts to be securely supported by side walls 120 while enabling their smooth rotation. While device 100 is illustrated hereinabove with a single, front rigid shaft 131 supported by engageable supports 121 with bolt connections comprising cylindrical holes 322, alternative configurations of device 100 may comprise various combinations of bolted supports 121, grooved recessed supports, and combinations thereof.

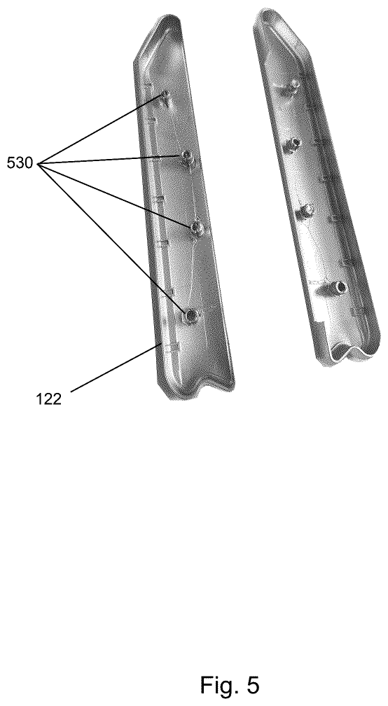

FIG. 5 shows the inner face of side covers 122 and exemplary connection means with side walls 120, according to an embodiment of the present invention. Extending from the inner surface of side covers 122 are attachment protrusions 530 configured to firmly engage with corresponding attachment holes 330 of side walls 120 (e.g., shown in FIGS. 3 and 6).

FIG. 6 illustrates an exemplary assembly of device 100 with one side cover 122 removed, exposing the engagement of connectors 210 of rigid shafts 130 with engageable supports 121 comprising recessions 321, and the assembly of rigid shaft 131 connected to side walls 120 through cylindrical holes 322 by bolts 632.

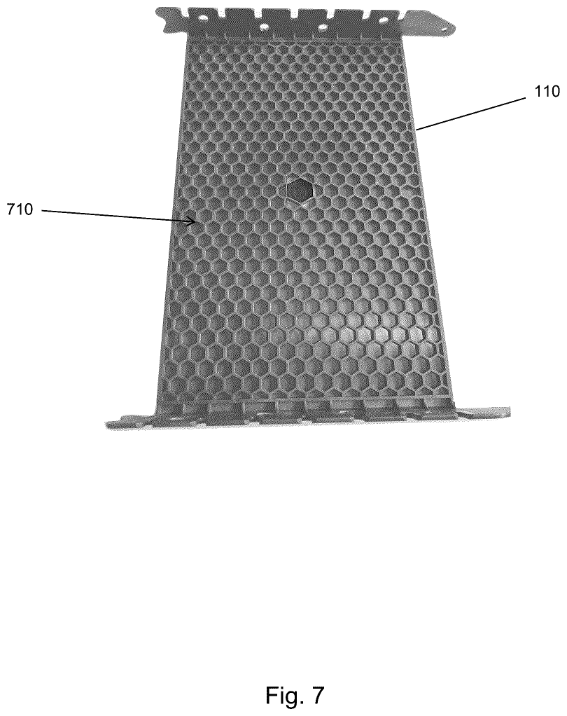

FIG. 7 illustrates an optional design of base 110 that comprises honeycomb-shaped reinforcement ribs 710 to provide a robust, durable structure of base 110.

To further enhance the operational stability of the device 100 during use, the underside of the base 110 may optionally comprise one or more anti-slip features. For example, high-friction elements such as silicone pads, rubberized mats, or suction cups may be affixed to or integrally formed with the bottom surface of the base 110 to prevent unintended lateral or longitudinal sliding of the device 100 relative to the sitting surface. Furthermore, in certain embodiments, the base 110 may include securing mechanisms, such as adjustable straps, buckles, or clips extending therefrom, configured to physically anchor the device 100 to the sitting surface or a structural component of a chair, thereby ensuring maximum stability even during vigorous forward and rearward movement by the seated user.

1. An exercise device, comprising:
a) a base configured to facilitate stable placement of said exercise device on a sitting surface;
b) side walls that vertically extend from the lateral ends of said base, said side walls comprise multiple engageable supports configured to receive and rotatably support the ends of a plurality of rigid shafts arranged therebetween; and
c) said plurality of rigid shafts configured to support a person seated thereon, said rigid shafts are horizontally arranged between said side walls and are rotatably connected thereto via said engageable supports,
wherein said engageable supports are interspaced, and are elevated relative to said base to enable the free rotation of the supported rigid shafts and, thereby, the forward and rearward movement of a person seated thereon.

2. A device according to claim 1, wherein the interspacing between the engageable supports and the diameter of said rigid shafts are predetermined to distribute the pressure applied by said rigid shafts on body portions of the seated person.

3. A device according to claim 1, wherein one or more engageable supports comprise recessions in the side walls.

4. A device according to claim 1, wherein one or more engageable supports comprise cylindrical holes in the side walls.

5. A device according to claim 1, wherein one or more ends of the plurality of rigid shafts comprise end connectors configured to secure their rotatable connection with the engageable supports of the side walls.

6. A device according to claim 1, wherein at least one rigid shaft is differently deployed with respect to other rigid shafts.

7. A device according to claim 6, wherein the corresponding rigid shaft is positioned beyond a front or a rear end of the base.

8. A device according to claim 6, wherein at least two rigid shafts are deployed to form a deployment pattern that promotes a corresponding movement pattern of a person seated on said device.

9. A device according to claim 1, wherein the base is reinforced with honeycomb-shaped ribs.

10. A device according to claim 5, wherein the end connectors comprise a neck section establishing a clamping depression aligned with the engageable supports, and an outermost clamping portion having a larger diameter than the engageable supports to secure the rotational connection.

11. A device according to claim 10, wherein the neck section comprises honed portions configured to permit passage through the engageable supports only when the rigid shaft is rotated to a specific alignment angle.

12. A device according to claim 5, wherein the end connectors comprise an abradable surface material having a lower wear resistance than a material of the engageable supports, thereby isolating frictional wear to the replaceable end connectors.

13. A device according to claim 3, wherein the recessions comprise a cylindrical support portion and an engagement groove located above the cylindrical support portion, wherein the engagement groove is narrower than the cylindrical support portion to prevent unintended disengagement of the rigid shafts.

14. A device according to claim 1, further comprising a high-friction anti-slip layer disposed on an underside of the base to prevent movement of the device relative to the sitting surface.
